(19) United States
(12) Patent Application Publication
(10) Pub. No.: US 2006/0106821 A1
(43) Pub. Date: May 18, 2006

(54) Ownership management of containers in an application server environment

(75) Inventors: David E. Cox, Raleigh, NC (US); Craig M. Lawton, Raleigh, NC (US); Jonathan A. Lewis, Morrisville, NC (US); Christopher A. Peters, Round Rock, TX (US); Lorin E. Ullmann, Austin, TX (US)

Correspondence Address: IBM CORP (WSM);C/O WINSTEAD SECHREST & MINICK P.C., PO BOX 50784, DALLAS, TX, 75201, US

(73) Assignee: International Business Machines Corporation, Armonk, NY (US)

(21) Appl. No.: 10/988,470

(22) Filed: Nov. 12, 2004

(51) Int. Cl. G06F 7/00

(52) U.S. Cl. 707/100

(57) ABSTRACT

A method, computer program product and system for determining ownership of containers. An installer program may edit stored information, such as ownership, about software component(s) it installed in a container. Upon a subsequent installer program planning to install a software component in that container, software, referred to as a “collector,” may identify the owners of the software components stored in that container. The collector may then search the rules in a rules database to determine the ownership of the container based on the ownership of the software components in the container. By mapping the software components stored in a container with their respective owners, the ownership of a container may be determined.

### TECHNICAL FIELD

The present invention relates to the field of installation programs, and more particularly to determining the ownership of containers.

### BACKGROUND INFORMATION

An installer program enables a programmer to write specific code to install a given application program onto the drives of a computer in a way that enables the given application program to work correctly with the computer's environment, including its operating system. There are several types of installers, such as Java installers and operating system specific installers, e.g., Microsoft Windows installers, International Business Machine's (“IBM's”) OS/2 and AIX operating system installers.

An installer program may also install software components, such as the software components of Sun's Java 2 Platform, Enterprise Edition (J2EE) platform (JavaBeans, Enterprise JavaBeans (EJBs), JavaServer Pages (JSPs) and Java Servlets), in what is commonly referred to as “containers.” Each container may be designated to hold particular types of software components. For example, a container referred to as a “web container” may be configured to hold JSPs and Java Servlets; while, a container referred to as a “EJB container” may be configured to hold EJBs.

Containers may be stored in what are referred to as “application servers” which may refer to software in an Intranet/Internet environment that hosts a variety of language systems used to program database queries and/or general business processing. For example, the JSPs stored in a container in the application server may be used to access a database to retrieve up-to-date data that is presented to users via their browsers or client applications. An application server may reside in the same computer as a “Web” server (also referred to as an HyperText Transport Protocol (HTTP) server) or in a separate computer.

During the installation of software components in a single shared container (container storing multiple software components) within an application server, it may be required to determine the ownership of the single shared container. If the container belongs to an owner with a license with provisions that prohibit the installation of certain software components in the container, then such software components should not be installed in the container. Hence, there is a need to determine ownership of containers prior to the installation of software components in a container.

### SUMMARY

The problems outlined above may at least in part be solved in some embodiments by mapping the software components stored in a container with their respective owners in a registry, a software unit (also referred to herein as a “ownership mapping unit”), a database, a file, a storage unit, or an application (via an Application Programming Interface (API)). Software, referred to herein as a “collector,” may identify the owners of the software components stored in the container by searching the registry, ownership mapping unit, database, file, or storage unit or application. The collector may then search the rules in a rules database to determine the ownership of the container based on the ownership of the software components in the container.

In one embodiment of the present invention, a method for determining ownership of a container may comprise the steps of identifying one or more software components stored in the container, identifying one or more owners of the one or more software components in the container, and searching rules to identify the ownership of the container based on the one or more owners of the one or more software components in the container.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE DRAWINGS

A better understanding of the present invention can be obtained when the following detailed description is considered in conjunction with the following drawings, in which:

FIG. 1 illustrates an embodiment of the present invention of a computer system;

FIG. 2 illustrates an embodiment of the present invention of an application server;

FIG. 3 illustrates an embodiment of the present invention of a registry;

FIG. 4 illustrates an embodiment of the present invention of the software components used in determining the ownership of a container;

FIG. 5 is a flowchart of a method for storing pertinent information regarding software components that have been installed in a container in accordance with an embodiment of the present invention; and

FIG. 6 is a flowchart of a method for determining the ownership of a container in accordance with an embodiment of the present invention.

### DETAILED DESCRIPTION

The present invention comprises a method, computer program product and system for determining ownership of containers. In one embodiment of the present invention, an installer program may edit a registry, a software unit (also referred to herein as a “ownership mapping unit”), a database, a file, a storage unit, or an application to store information, such as ownership, about software component(s) it installed in a container. Upon a subsequent installer program planning to install a software component in that container, software, referred to herein as a “collector,” may identify the owners of the software components stored in that container by searching the registry, ownership mapping unit, database, file, storage unit, or application. The collector may then search the rules in a rules database to determine the ownership of the container based on the ownership of the software components in the container. By mapping the software components stored in a container with their respective owners in the registry, ownership mapping unit, database, file, storage unit, or application, the ownership of a container that may store multiple applications may be determined. Upon determining ownership of the container, the collector may determine if there is any incompatibility or licensing issues with the software component to be installed as discussed herein.

Although the present invention is described with reference to determining the ownership of containers in application servers, it is noted that the principles of the present invention may be applied to determining the ownership of containers in any type of software application. It is further noted that embodiments applying the principles of the present invention to determining the ownership of containers in applications other than application servers would fall within the scope of the present invention.

In the following description, numerous specific details are set forth to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

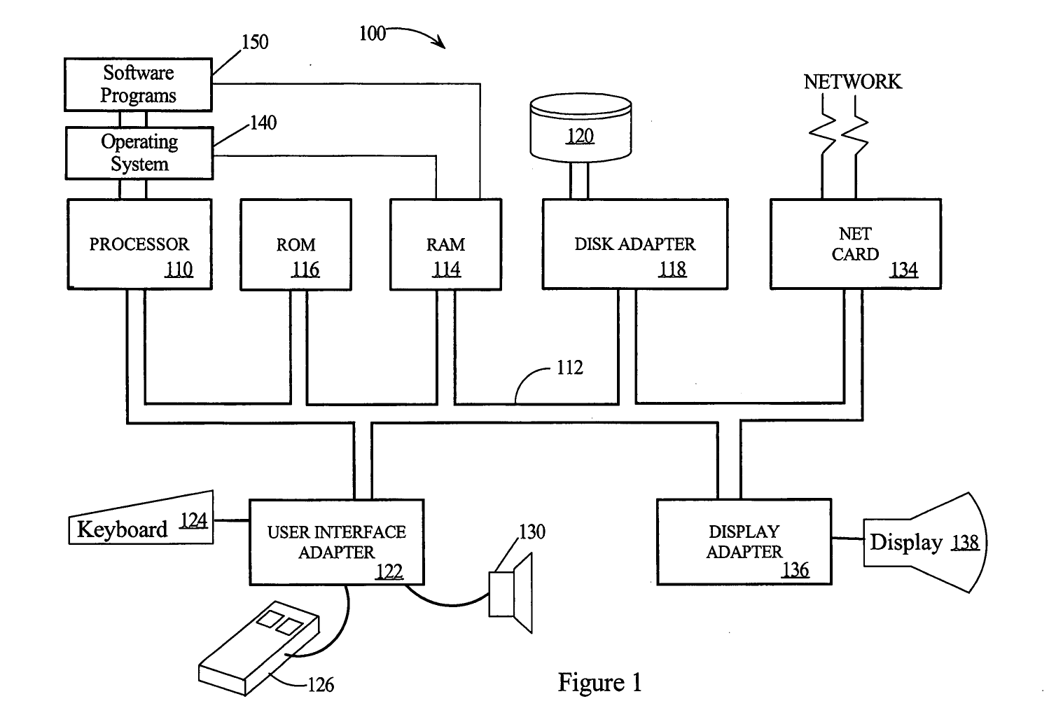

FIG. 1—Computer System

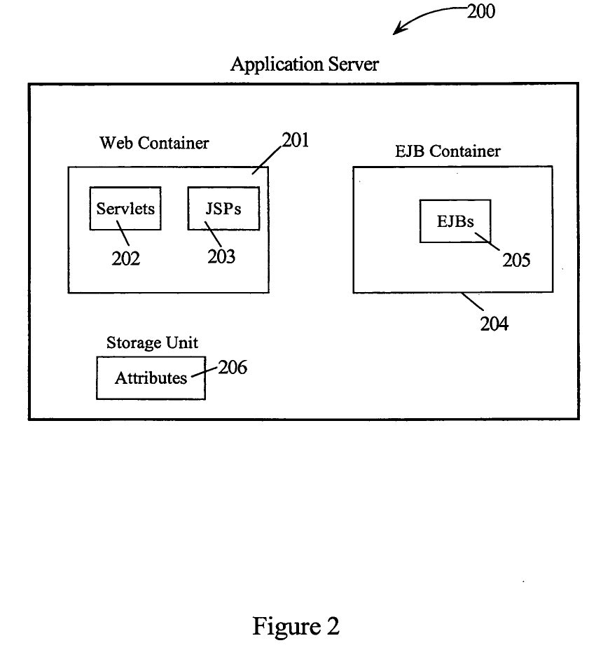

FIG. 1 illustrates a typical hardware configuration of computer system 100 which is representative of a hardware environment for practicing the present invention. Computer system 100 may have a processor 110 coupled to various other components by system bus 112. A more detail description of processor 110 is described below in conjunction with FIG. 2. An operating system 140 may run on processor 110 and provide control and coordinate the functions of the various components of FIG. 1. Software programs 150, in accordance with the principles of the present invention, may run in conjunction with operating system 140 and provide calls to operating system 140 where the calls implement the various functions or services to be performed by software programs 150.

Software programs 150 may include, for example, an installer program, e.g., Platform Installation and Configuration Service (PICS). Software programs 150 may also include an application server, e.g., WebSphere™, storing containers, such as a web container and an EJB container. A more detailed description of an application server is provided below in association with FIG. 2.

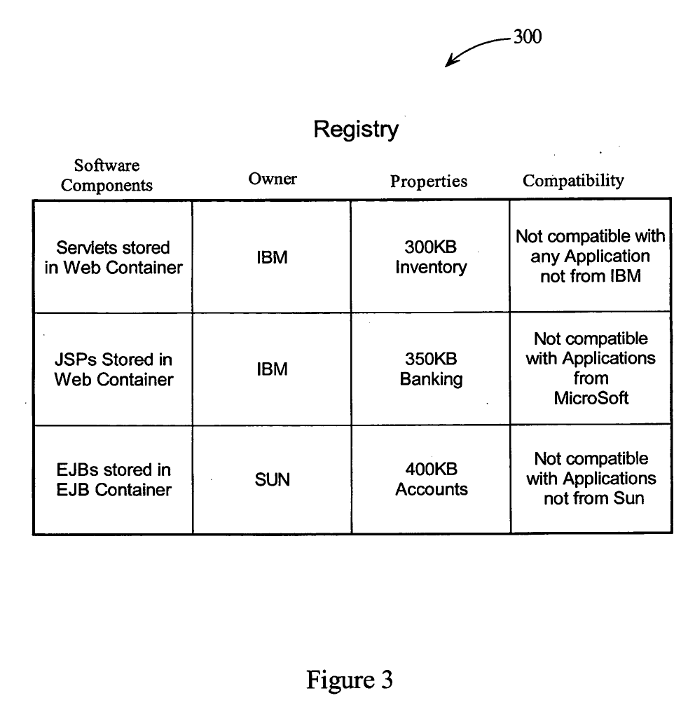

Software programs 150 may also include a registry used to store information, such as ownership, of the software components installed in a container. A more detailed description of such a registry is provided further below in association with FIG. 3.

Software programs 150 may also include a software unit, also referred to herein as a “ownership mapping unit,” used to store information, such as ownership, of the software components installed in a container.

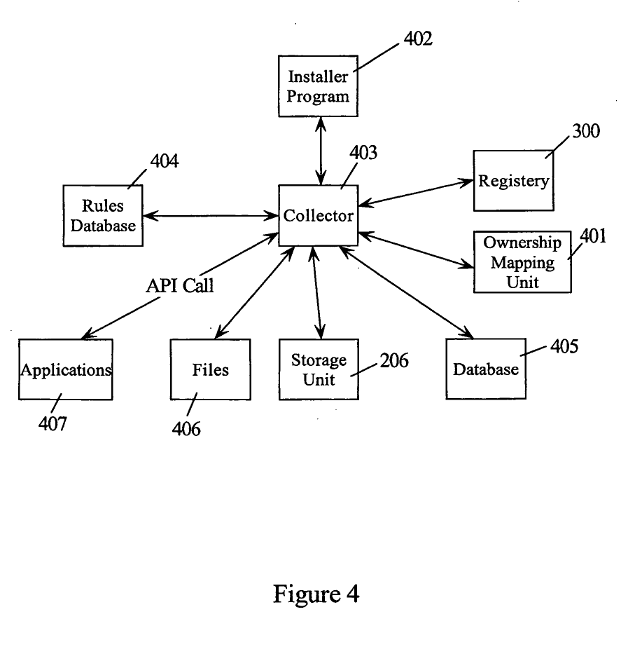

Software programs 150 may also include software, referred to herein as a “collector” and a “rules database.” A collector may determine the ownership of a container by searching rules in the rules database. In one embodiment, the collector may be part of the installer program. A more detailed description of such a collector, ownership mapping unit and rules database is provided further below in association with FIG. 4.

Software programs 150 may also include code to generate a graphical user interface on display 138 (discussed below) which may be a combination of menus, screen designs, icons and online help, which creates a way a user interacts with system 100.

Read-Only Memory (ROM) 116 may be coupled to system bus 112 and include a basic input/output system (“BIOS”) that controls certain basic functions of computer system 100. Random access memory (RAM) 114 and disk adapter 118 may also be coupled to system bus 112. It should be noted that software including operating system 140 and software programs 150 may be loaded into RAM 114 which may be computer system's 100 main memory for execution. Disk adapter 118 may be an integrated drive electronics (“IDE”) adapter that communicates with a disk unit 120, e.g., disk drive. It is noted that software mentioned above that may reside in software programs 150 may also reside in disk unit 120.

Referring to FIG. 1, computer system 100 may further comprise a communications adapter 134 coupled to bus 112. Communications adapter 134 may interconnect bus 112 with an outside network enabling computer system 100 to communicate with other such systems. I/O devices may also be connected to system bus 112 via a user interface adapter 122 and a display adapter 136. Keyboard 124, mouse 126 and speaker 130 may all be interconnected to bus 112 through user interface adapter 122. Event data may be inputted to computer system 100 through any of these devices. A display monitor 138 may be connected to system bus 112 by display adapter 136. In this manner, a user is capable of inputting to computer system 100 through keyboard 124 or mouse 126 and receiving output from computer system 100 via display 138 or speaker 130.

Implementations of the invention include implementations as a computer system programmed to execute the method or methods described herein, and as a computer program product. According to the computer system implementations, sets of instructions for executing the method or methods may be resident in the random access memory 114 of one or more computer systems configured generally as described above. Until required by computer system 100, the set of instructions may be stored as a computer program product in another computer memory, for example, in disk unit 120. Furthermore, the computer program product may also be stored at another computer and transmitted when desired to the user's workstation by a network or by an external network such as the Internet. One skilled in the art would appreciate that the physical storage of the sets of instructions physically changes the medium upon which it is stored so that the medium carries computer readable information. The change may be electrical, magnetic, chemical or some other physical change.

FIG. 2—Application Server

FIG. 2 illustrates an embodiment of the present invention of an application server 200. Application server 200 may refer to software in an Intranet/Iernet environment that hosts a variety of language systems used to program database queries and/or general business processing. Application server 200 may store one or more “containers.” For example, application server 200 may store a container, referred to herein as a “web container” 201, used to store software components such as servlets 202 and JSPs 203. Application server 200 may also store a container, referred to herein as an “EJB container” 204, used to store EJBs 205. It is noted that FIG. 2 is illustrative and that application server 200 may store any number of containers storing any number of software components.

In one embodiment, application server 200 may additionally store attributes in a storage unit 206 associated with containers 201, 204. These attributes may include information such as ownership, properties and compatibility information about containers 201, 204 stored in application server 200. A further description of such information is discussed below in connection with a registry (see FIG. 3). In one embodiment, such attributes may be stored in storage unit 206 by an installer program during the installation of containers 201, 204 (see FIG. 4).

As stated in the Background Information section, during the installation of software components in a single shared container within an application server, it may be required to determine the ownership of the single shared container. If the container belongs to an owner with a license with provisions that prohibit the installation of certain software in the container, then such software components should not be installed in the container. Hence, there is a need to determine ownership of containers prior to the installation of software components in a container. The ownership of a container may be known when the container stores a single software component and is embedded within a product, e.g., application server. However, no other software components may share such a container in order to preserve the “privacy” of the location of the container. That is, each software component must be stored in its own container. By having each software component stored in its own container, the cost of information technology support is greatly increased. Hence, it may not be feasible in many customer environments to have each software component stored in its own container. Therefore, there is a need in the art to determine ownership of containers that may store multiple software components. The ownership of containers that may store multiple software components may be determined using a registry, as described in association with FIG. 3, an “ownership mapping unit,” a database, a storage unit 206, a file, or an application, as described in association with FIG. 4.

FIG. 3—Registry

FIG. 3 illustrates an embodiment of the present invention of a registry 300 configured to store information, such as ownership, of each the software components stored in each container, e.g., containers 201, 204, within application server 200. In one embodiment, an installer program (referring to an installer program that may reside in software programs 150 of FIG. 1) may install a software component, e.g., JSPs 203, within a container, e.g., container 201, of application server 200. The installer program may then be configured to edit registry 300, as illustrated in FIG. 3, to store information regarding the installed software component, such as its owner, properties and compatibility. For example, referring to FIGS. 2 and 3, the ownership, properties and compatibility of servlets 202 may be stored in registry 300. As illustrated in FIG. 3, servlets 202 are owned by IBM™ with a size of 400 Kilobytes (KB) and are inventory data. Further, servlets 202 are not compatible with any application that is not from IBM™. In another example, the ownership, properties and compatibility of JSPs 203 may be stored in registry 300. As illustrated in FIG. 3, JSPs are owned by IBM™ with a size of 350 KB and are banking data. Further, JSPs are not compatible with any application from Microsoft™. In another example, the ownership, properties and compatibility of EJBs 205 may be stored in registry 300. As illustrated in FIG. 3, EJBs are owned by Sun Microsystems™ with a size of 400 KB and are accounts data. Further, EJBs are not compatible with any application not from Sun Microsystems™. It is noted that registry 300 may store other information than depicted in FIG. 3 and that FIG. 3 is illustrative.

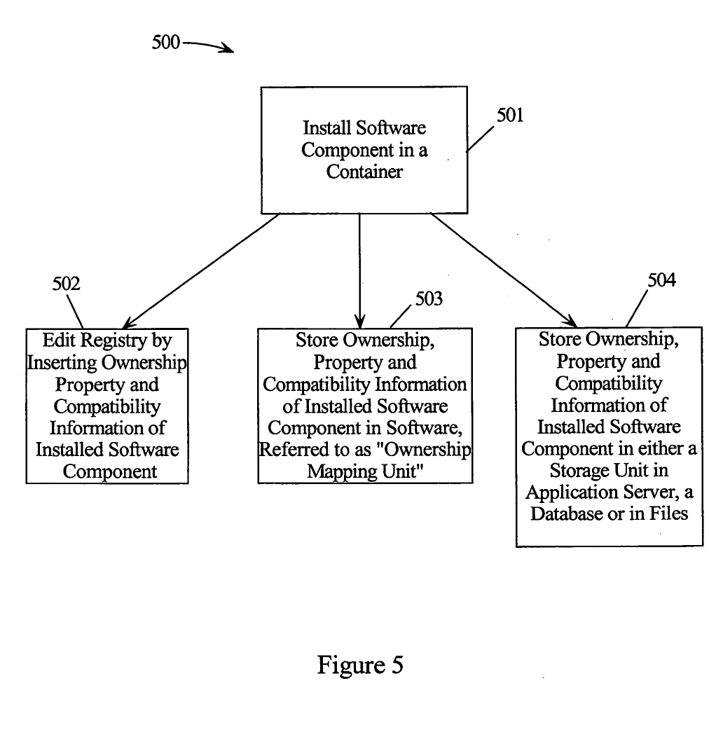

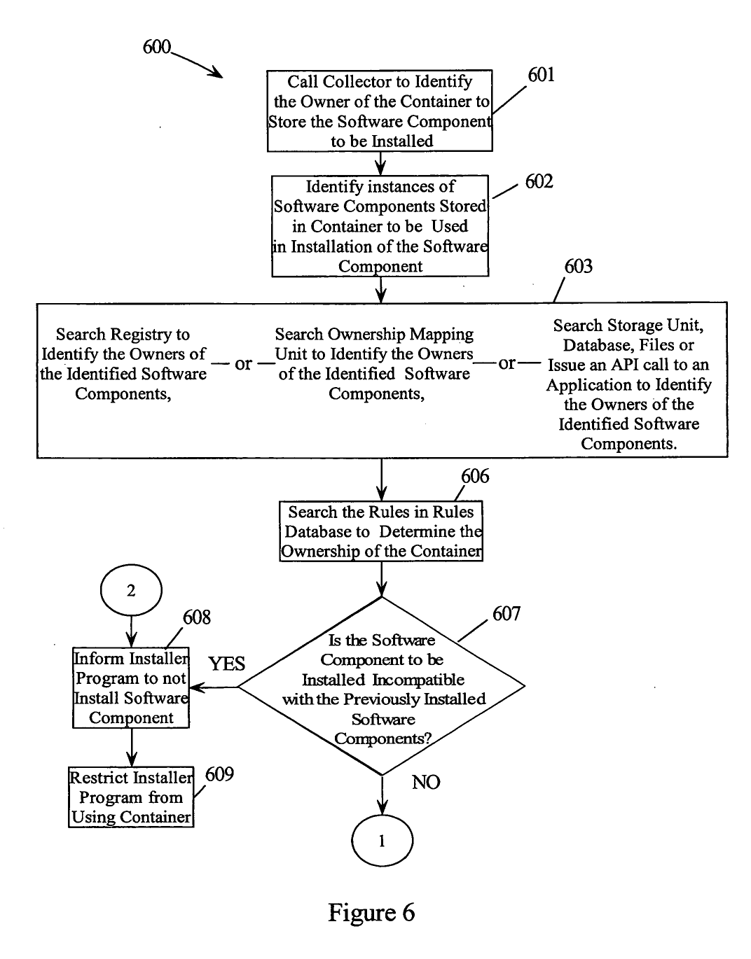

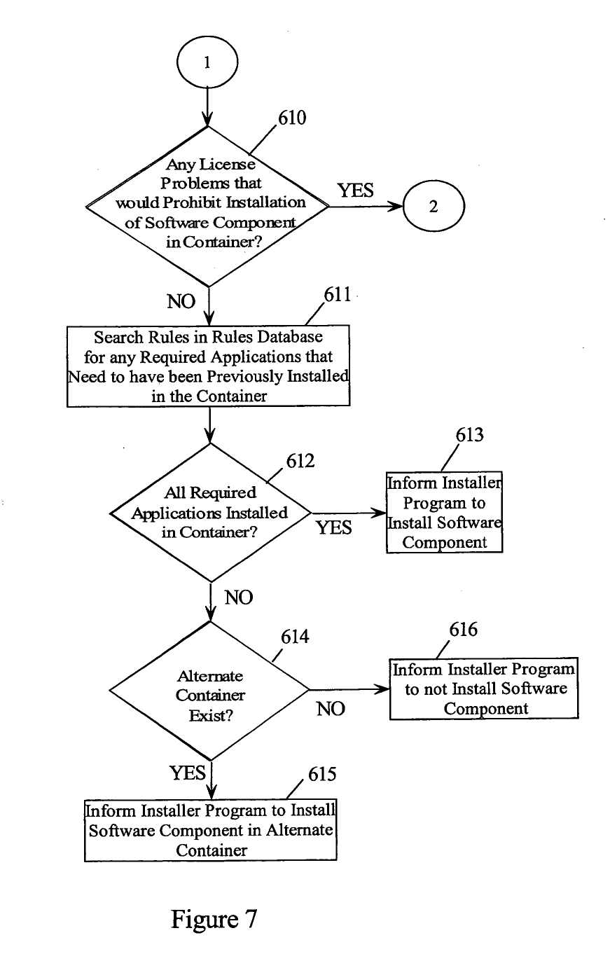

By mapping the software components stored in containers within application server 200 with their respective owners in registry 300, the ownership of a container may be determined as discussed further below in association with FIGS. 5-6. FIG. 5 is a flowchart of a method for storing pertinent information regarding software components that have been installed in a container. FIG. 6 is a flowchart of a method for determining the ownership of a container. Prior to such a discussion, a description of alternative embodiments to storing information regarding an installed software component, such as its ownership, properties and compatibility, in registry 300 is provided below.

FIG. 4—Software Components Used to Determine Ownership of Containers

FIG. 4 illustrates an embodiment of the present invention of software components used in determining ownership of containers, e.g., web container 201 and EJB container 204 in application server 200 (FIG. 2).

Referring to FIG. 4, upon initialization of an installer program 402 to install a software component within a particular container, installer program 402 may call software, referred to herein as a “collector” 403, to identify the owner of the container to store the software component to be installed. In one embodiment, collector 403 may be part of installer program 402. Installer program 402 may provide an identification of the container to collector 403. Collector 403 may then be configured to identify the software components stored in that container. Upon identifying the instances of the software components within the container planned to be used in the installation, collector 403 determines the ownership of those software components.

In one embodiment, collector 403 determines the ownership of those software components by searching registry 300 to locate the identified software components, e.g., servlets 202, JSPs 203, within the container, e.g., container 201, planned to be used in the installation of the software component.

In another embodiment, collector 403 determines the ownership of those software components by searching ownership mapping unit 401 to locate the identified software components, e.g., servlets 202, JSPs 203, within the container, e.g., container 201, planned to be used in the installation of the software component.

In another embodiment, collector 403 determines the ownership of those software components by searching a database 405 configured to store information such as ownership, properties and compatibility information (similar to the information stored in registry 300) about containers 201, 204. In one embodiment, such information may be stored in database 405 by installer program 402 during the installation of containers 201, 204. In one embodiment, database 405 may be stored in disk unit 120 (FIG. 1) or as a separate unit coupled to system 100 (FIG. 1).

In another embodiment, collector 403 determines the ownership of those software components by searching storage unit 206 (FIG. 2).

In another embodiment, collector 403 determines the ownership of those software components by searching files 406 configured to store information such as ownership, properties and compatibility information (similar to the information stored in registry 300) about containers 201, 204. In one embodiment, such information may be stored in files 406 by installer program 402 during the installation of containers 201, 204. In one embodiment, files 406 may be stored in disk unit 120 (FIG. 1) or as a separate unit coupled to system 100 (FIG. 1).

In another embodiment, collector 403 determines the ownership of those software components by issuing an Application Programming Interface (API) call to an application 407, e.g., web services application, configured to locate and provide information such as ownership, properties and compatibility information (similar to the information stored in registry 300) about containers 201, 204.

Upon identifying the ownership of the software components stored within the container planned to be used in the installation, collector 403 may search through the rules in rules database 404 to determine the ownership of the container storing those software components. Rules database 404 may refer to a database that stores a set of “rules” used in determining the ownership of containers. For example, one rule could be that a container that stores only a single software component is owned by the owner of that software component. Another rule could be that the container is owned by the owner of the most software components in that container. In this manner, the ownership of containers that may store multiple software components may be determined.

In other embodiments, the information contained in rules database 404 may also be stored in either registry 300, ownership mapping unit 401, database 405, storage unit 206 or files 406, or may be obtained by application 407 via an API call from collector 403. It is noted that the description below that describes collector 403 searching the rules in rules database 403 may apply to any of the other units, e.g., registry 300, ownership mapping unit 401, database 405, storage unit 206, files 406, API call 407 described above.

Upon identifying the ownership of the container planned to be used in the installation of the software component, collector 403 may further be configured to determine whether there are any potential conflicts (referring to incompatibility or licensing problems) with the software component to be installed and the previously installed software components, e.g., servlets 202, JSPs 203, in the container. In one embodiment, collector 403 may search the rules in rules database 404 to determine whether the software component to be installed by installer program 402 is incompatible with the previously installed software components, installed in the container. For example, if the software component was to be installed in a container containing servlets 202 and JSPs 203, then rules database 404 may include information indicating that servlets 202 are not compatible with any application that is not from IBM™. Rules database 404 may further include information that JSPs 203 are not compatible with any application from Microsoft™. If the software component to be installed was an application from Microsoft™, then the software component to be installed would be incompatible with JSPs 203 and hence may not be able to be installed. In another embodiment, collector 403 may search registry 300 to determine whether the software component to be installed by installer program 402 is incompatible with the previously installed software components, e.g., servlets 202, JSPs 203, in the container, e.g., container 201. As stated above, registry 300 may contain incompatibility information for each of the software components stored in each container as illustrated in FIG. 3.

Collector 403 may further be configured to search rules database 404 for any licensing problems that would prohibit the installation of the software component in the container. For example, the owner of the container may have signed a license agreement with a supplier, e.g., IBM™, that prohibits installing applications from a certain vendor. If the software component to be installed is from that vendor, then the application should not be installed thereby not violating that license agreement. In one embodiment, rules database 404 may be configured to store the licensing provisions related to prohibitions against installing particular applications for each installed software component, e.g., servlets 202, in a container, e.g., container 201.

Collector 403 may further be configured to search rules database 404 for any required applications that need to have been previously installed in the container in order for the software component to be installed. For example, suppose the software component to be installed in a container, e.g., container 201, requires application 1 and application 2 from IBM™. If neither of these applications were detected by collector 403 in the container, then the software component may not be able to be installed in that container. Collector 403 may be configured to determine if the software component can be installed in another container that meets these requirements (contains application 1 and application 2 from IBM™ and does not contain any additional applications that would cause any incompatibility or licensing issues).

A description of determining the ownership of containers as well as determining if there are any incompatibility, licensing or requirement issues, as described above, using the elements described in association with FIGS. 3 and 4 is described below in association with FIG. 6. Prior to such a discussion, a method for storing pertinent information regarding software components that have been installed in a container is provided below in association with FIG. 5.

FIG. 5—Method for Storing Pertinent Information Regarding Software Components Installed in a Container

FIG. 5 is a flowchart of one embodiment of the present invention of a method 500 for storing pertinent information, e.g., ownership, properties, compatibility, about the software components, e.g., servlets 202 installed in container 201 (FIG. 2).

Referring to FIG. 5, in conjunction with FIGS. 1-4, in step 501, installer program 402 installs a software component, e.g., servlets 202, in a container, e.g., container 201, in an application server 200.

Upon installing a software component, installer program 402, in step 502, edits registry 300 by inserting pertinent information, such as ownership, properties and compatibility, about the installed software component. For example, if installer program 402 installed servlets 202, then installer program 402 may edit registry 300 by indicating that the owner of servlets 202 is IBM™ and that servlets 202 have a size of 350 KB and are inventory data as illustrated in FIG. 3. Further, installer program 402 may edit registry 300 by indicating that servlets 202 are not compatible with any application not from IBM™ as illustrated in FIG. 3.

Alternatively, upon installing a software component, installer program 402, in step 503, stores pertinent information, such as ownership, properties and compatibility, about the installed software component in ownership mapping unit 401.

Alternatively, upon installing a software component, installer program 402, in step 504, stores pertinent information, such as ownership, properties and compatibility, about the installed software component in either storage unit 206, database 405, files 406, or application 407.

It is noted that method 500 may include other and/or additional steps that, for clarity, are not depicted. It is further noted that method 500 may be executed in a different order presented and that the order presented in the discussion of FIG. 5 is illustrative. It is further noted that certain steps in method 500 may be executed in a substantially simultaneous manner.

As stated above, method 500 is a method for storing pertinent information, e.g., ownership, properties, compatibility, about the installed software components. Upon storage of this information, a subsequent installer program may use such information to determine the ownership of the container to store the application to be installed by this installer program as well as to determine if there are any compatibility, licensing or requirement issues as discussed below in association with FIG. 6.

FIG. 6—Method for Determining the Ownership of Containers

FIG. 6 is a flowchart of one embodiment of the present invention of a method 600 for determining the ownership of containers, e.g., container 201 (FIG. 2).

Referring to FIG. 6, in conjunction with FIGS. 1-5, in step 601, upon installation, installer program 402 calls collector 403 to determine the ownership of the container to be used in storing the software component to be installed. In one embodiment, installer program 402 may provide an identification of the container to collector 403.

In step 602, collector 403 identifies instances of the software components, e.g., servlets 202, JSPs 203, within the container, e.g., container 201, planned to be used in the installation of the software component.

In step 603, collector 403 searches registry 300 to identify the owners of the identified software components. For example, if installer program 402 is to install the software component in container 201, then servlets 202 and JSPs 203 would be identified in step 601. Collector 403 may then identify that the owner of servlets 202 and JSPs is IBM™ as illustrated in FIG. 3.

Alternatively, in step 604, collector 403 searches ownership mapping unit 401 to identify the owners of the identified software components.

Alternatively, in step 605, collector 403 searches either storage unit 206, database 405, files 406 or issues an API call to application 407 to identify the owners of the identified software components.

Upon searching registry 300, ownership mapping unit 401, storage unit 206, database 405, files 406 or issuing an API call to application 407 to identify the owners of the identified software components, collector 403, in step 606, searches the rules in rules database 404 to determine the ownership of the container, planned to be used in the installation of the software component. A description of using the rules in the rules database 404 to determine the ownership of the container, planned to be used in the installation of the software component is provided above and will not be reiterated for the sake of brevity. As stated above, in other embodiments, the information contained in rules database 404 may also be stored in either database 405, storage unit 206 or files 406 or may be obtained by application 407 via an API call from collector 403. It is noted that the description below that describes collector 403 searching the rules in rules database 403 may apply to any of the other units, e.g., database 405, storage unit 206, files 406, described above.

In step 607, upon identifying the owner of the container, to be used in the installation of the software component, collector 403 determines if the software component to be installed is incompatible with the previously installed software components, e.g., servlets 202, JSPs 203, in the container. As stated above, collector 403 may use either the information in registry 300 or the rules in rules database 404 to determine if the software component to be installed is incompatible with the software components previously installed in the container.

If the software component to be installed is incompatible with the previously installed software components in the container, then, in step 608, installer program 402 is informed by collector 403 to not install the application. In step 609, installer program 402 is restricted from further use of the container. If the user of installer program 402 desires to use the restricted container, the user may contact the owner of the container to obtain permission to use the container. It is noted that the owner of a container may involve multiple parties and hence the user may have to contact multiple parties.

If, however, the software component to be installed is compatible with the previously installed software components in the container, then, in step 610, collector 403 determines if there are any licensing problems that would prohibit the installation of the software component in the container. As stated above, collector 403 may use the rules in rules database 404 to determine if there are any licensing problems that would prohibit the installation of the software component in the container.

If there are licensing problems that would prohibit the installation of the software component in the container, then, in step 608, installer program 402 is informed by collector 403 to not install the application.

If, however, there are no licensing problems that would prohibit the installation of the software component in the container, then, in step 611, collector 403 searches the rules in rules database 404 for any required applications that need to have been previously installed in the container. As stated above, collector 403 may use the rules in rules database 404 to determine if there are any required applications that need to have been previously installed in the container.

In step 612, collector 403 determines if all of these required applications, if any, have been previously installed in the container.

If collector 403 determines that all of these required applications, if any, have been previously installed in the container, then, in step 613, installer program 402 is informed by collector 403 to install the software component.

If, however, collector 403 determines that not all of these required applications have been previously installed in the container, then, in step 614, collector 403 determines if the software component can be installed on another container that meets these requirements. Collector 403 may determine if another container meets these requirements as well as ensuring that there are no incompatibility or licensing issues using the rules in rules database 404 as described above as well as using registry 300, ownership mapping unit 401, storage unit 206, database 405, files 406, or issuing an API call to application 407 to identify the owners of the software components in other components.

If collector 403 determines that the software component cannot be installed on another container that meets these requirements, then, in step 608, installer program 402 is informed by collector 403 to not install the software component.

If, however, collector 403 determines that the software component can be installed on an alternative container that meets these requirements, then, in step 615, installer program 402 is informed by collector 403 to install the software component in the alternative container.

It is further noted that method 600 may include other and/or additional steps that, for clarity, are not depicted. It is further noted that method 600 may be executed in a different order presented and that the order presented in the discussion of FIG. 6 is illustrative. It is further noted that certain steps in method 600 may be executed in a substantially simultaneous manner.

Although the method, system and computer program product are described in connection with several embodiments, it is not intended to be limited to the specific forms set forth herein, but on the contrary, it is intended to cover such alternatives, modifications and equivalents, as can be reasonably included within the spirit and scope of the invention as defined by the appended claims. It is noted that the headings are used only for organizational purposes and not meant to limit the scope of the description or claims.

1. A method for determining ownership of a container comprising the steps of:
identifying one or more software components stored in said container;
identifying one or more owners of said one or more software components in said container; and
searching rules to identify the ownership of said container based on said one or more owners of said one or more software components in said container.

2. The method as recited in claim 1, further comprising the steps of:
determining if a first software component to be installed by an installer program in said container is incompatible with the ownership of said one or more software components in said container; and
informing said installer program to not install said first software component if said first software component is incompatible with the ownership of said one or more software components in said container.

3. The method as recited in claim 1, further comprising the steps of:
determining if a first software component to be installed by an installer program in said container is prohibited from being installed in said container due to a license agreement by searching said rules; and
informing said installer program to not install said first software component if said license agreement prohibits installation of said first software component.

4. The method as recited in claim 3, further comprising the steps of:
searching said rules to determine if a required application needs to have been previously installed in said container if said first software component is not prohibited from being installed in said container; and
informing said installer program to install said first software component in an alterative container if said container did not contain said required application and said alternative container contained said required application.

5. A computer program product embodied in a machine readable medium for determining ownership of a container, comprising the programming steps of:
identifying one or more software components stored in said container;
identifying one or more owners of said one or more software components in said container; and
searching rules to identify the ownership of said container based on said one or more owners of said one or more software components in said container.

6. The computer program product as recited in claim 5, further comprising the programming step of:
determining if a software component to be installed by an installer program in said container is incompatible with the ownership of said one or more software components in said container.

7. The computer program product as recited in claim 6, further comprising the programming step of:
informing said installer program to not install said software component if said software component is incompatible with the ownership of said one or more software components in said container.

8. The computer program product as recited in claim 7, further comprising the programming step of:
determining if the software component to be installed by said installer program in said container is prohibited from being installed in said container due to a license agreement by searching said rules.

9. The computer program product as recited in claim 8, further comprising the programming step of:
informing said installer program to not install said software component if said license agreement prohibits installation of said software component.

10. The computer program product as recited in claim 8, further comprising the programming step of:
searching said rules to determine if a required application needs to have been previously installed in said container if said software component is not prohibited from being installed in said container.

11. The computer program product as recited in claim 10, further comprising the programming step of:
informing said installer program to install said software component in an alterative container if said container did not contain said required application and said alternative container contained said required application.

12. A system, comprising:
a processor; and
a memory unit coupled to said processor, wherein said memory unit is operable for storing a computer program for determining ownership of containers;
wherein said processor, responsive to said computer program, comprises:
circuitry for identifying one or more software components stored in said container;
circuitry for identifying one or more owners of said one or more software components in said container; and
circuitry for searching rules to identify said ownership of said container based on said one or more owners of said one or more software components in said container.

13. The system as recited in claim 12, wherein said processor further comprises:
circuitry for determining if a software component to be installed by an installer program in said container is incompatible with said ownership of said one or more software components in said container; and
circuitry for informing said installer program to not install said software component if said software component is incompatible with said ownership of said one or more software components in said container.

14. The system as recited in claim 12, wherein said processor further comprises:
circuitry for determining if a software component to be installed by an installer program in said container is prohibited to be installed in said container due to a license agreement by searching said rules; and
circuitry for informing said installer program to not install said software component if said license agreement prohibits installation of said software component.

15. The system as recited in claim 14, wherein said processor further comprises:
circuitry for restricting said installer program from using said container.

16. The system as recited in claim 14, wherein said processor further comprises:
circuitry for searching said rules to determine if a required application needs to have been previously installed in said container if said software component is not prohibited to be installed in said container; and
circuitry for informing said installer program to install said software component in an alterative container if said container did not contain said required application and said alternative container contained said required application.
